(19) United States
(12) Patent Application Publication
(10) Pub. No.: US 2009/0144404 A1
(43) Pub. Date: Jun. 4, 2009

(54) LOAD MANAGEMENT IN A DISTRIBUTED SYSTEM

(75) Inventors: Alastair Wolman, Seattle, WA (US); John Dunagan, Bellevue, WA (US); Johan Ake Fredrick Sundstrom, Kirkland, WA (US); Richard Austin Clawson, Sammamish, WA (US); David Pettersson Rickard, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/949,777

(22) Filed: Dec. 4, 2007

(51) Int. Cl. G06F 15/173

(52) U.S. Cl. 709/223

(57) ABSTRACT

A technique for load management in a distributed system that includes multiple physical nodes is disclosed. The load management technique includes mutably assigning a number of virtual nodes to each physical node of the multiple physical nodes. A total number of virtual nodes assigned to the multiple physical nodes is maintained substantially unaltered in spite of any alterations made in the number of virtual nodes assigned to each physical node of the multiple physical nodes.

### BACKGROUND

Deploying multiple machines is a generic technique for improving system scalability. When the content to be stored in a system exceeds the storage capacity of a single machine, or the incoming request rate to the system exceeds the service capacity of a single machine, then a distributed solution is needed.

The discussion above is merely provided for general background information and is not intended to be used as an aid in determining the scope of the claimed subject matter.

### SUMMARY

The present embodiments provide methods and apparatus for load management in a distributed system that includes multiple physical nodes. In one embodiment, each physical node is a separate machine (for example, a separate server). An exemplary embodiment utilizes virtual nodes in a logical space to assist in providing access to individual physical nodes in a physical space. In this embodiment, the load management technique includes mutably assigning a number of virtual nodes to each physical node of the multiple physical nodes. Changing the number of virtual nodes assigned to a particular physical node helps change the load on that physical node. A total number of virtual nodes assigned to the multiple physical nodes is maintained substantially unaltered in spite of any alterations made in the number of virtual nodes assigned to each physical node of the multiple cache nodes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a simplified block diagram of a caching system.

FIG. 2 is a simplified block diagram of a caching system that employs consistent hashing.

FIG. 3 illustrates an exemplary system in which cache load management techniques in accordance with the present embodiments are employed.

FIG. 4 is a graphical representation of load balancing, in a distributed cache, carried out in accordance with the present embodiments.

FIG. 5 is a simplified flowchart showing steps of a method embodiment.

FIG. 6 is a block diagram that illustrates an example of a suitable computing system environment on which caching embodiments may be implemented.

### DETAILED DESCRIPTION

In general, the present embodiments relate to management of load in a distributed system. More specifically, the present embodiments relate to load balancing across multiple cache nodes in a distributed cache. In one embodiment, each cache node is a separate server. However, in other embodiments, a cache node can be any separately addressable computing unit, for example, a process on a machine that hosts multiple processes.

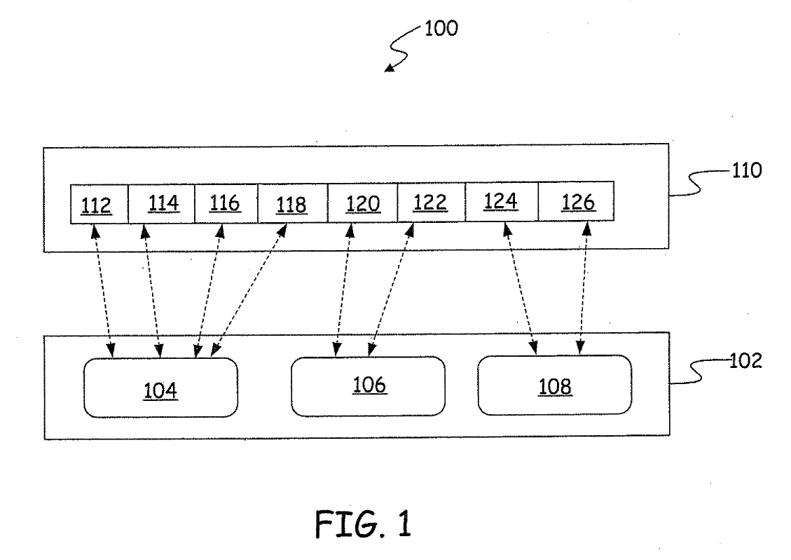

One embodiment uses consistent hashing to distribute the responsibility for a cache key space across multiple cache nodes. In such an embodiment, virtual nodes, which are described further below, are used for improving the “evenness” of distribution with consistent hashing. This specific embodiment utilizes a load management algorithm that governs the number of virtual nodes assigned to each active cache node in the distributed cache, along with mechanisms for determining load on each active cache node in the caching system and for determining machine membership within the distributed cache. However, prior to describing this specific embodiment in greater detail, a general embodiment that utilizes virtual nodes to help in load balancing is briefly described in connection with FIG. 1. The same reference numerals are used in the various figures to represent the same or similar elements.

FIG. 1 is a very simplified block diagram of a caching system 100 that utilizes virtual nodes in a logical space to help access individual cache nodes in a physical space that together constitute a distributed cache. In the interest of simplification, other components that enable the operation of caching system 100 are not shown.

In FIG. 1, the physical space that includes the distributed cache is denoted by reference numeral 102 and the individual cache nodes within the distributed cache are denoted by reference numerals 104, 106 and 108, respectively. It should be noted that the distributed cache with three cache nodes is just an example and, in general, the distributed cache can include any suitable number of cache nodes.

As can be seen in FIG. 1, the logical space, which is denoted by reference numeral 110, includes virtual nodes 112 through 126. Machine 104 is assigned four virtual nodes 112, 114, 116 and 118, machine 106 has two virtual nodes 120 and 122, and machine 108 is assigned two virtual nodes 124 and 126. Arbitrary techniques for dividing the logical space into ranges, sets of which are then mapped to physical nodes, may not have originally been described using the terminology of virtual nodes, but can be understood as example embodiments of the virtual node technique.

In general, changing the number of virtual nodes assigned to a particular cache node helps change the load on that cache node. However, in accordance with the present embodiments, a total number of virtual nodes assigned to the multiple cache nodes is maintained substantially unaltered in spite of any alterations made in the number of virtual nodes assigned to each cache node of the multiple cache nodes. Thus, in the example shown in FIG. 1, if one virtual node is eliminated from cache node 104, for example, a new virtual node is added to one of cache nodes 106 and 108. This helps keep the granularity of load moved in future virtual node reassignments substantially unaltered.

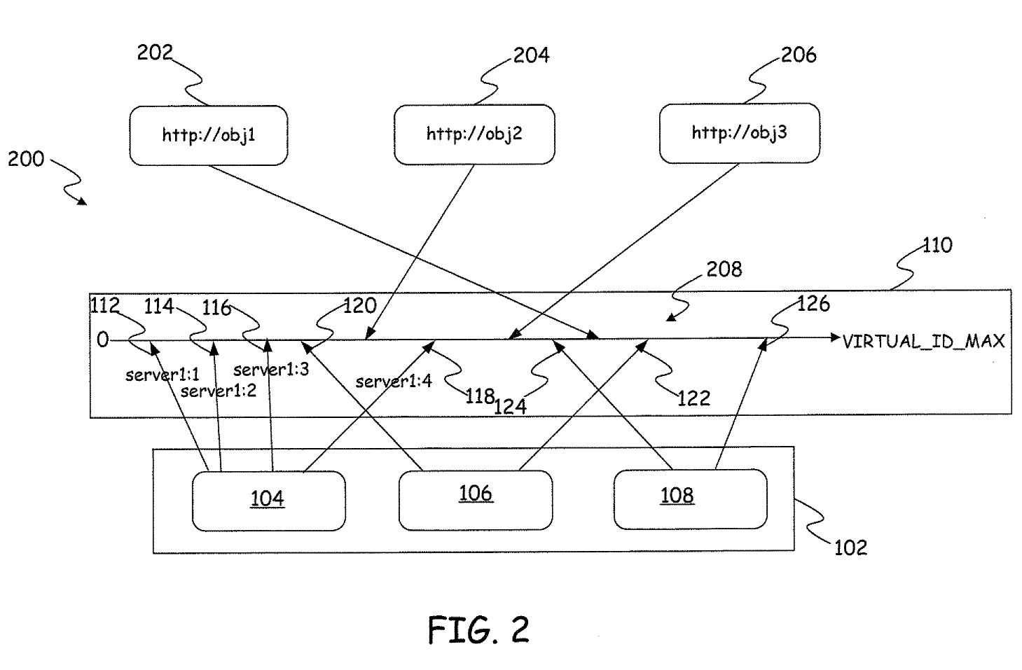

FIG. 2 is a simplified block diagram of a caching system 200 that employs consistent hashing. FIG. 2 illustrates how incoming requests to the cache, which are represented by boxes 202, 204 and 206, are appropriately directed using a consistent hashing technique.

A fundamental question that a mapping scheme utilized in the embodiment of FIG. 2 needs to solve is: given a cache key, where should it be mapped? A consistent hashing approach used in the embodiment of FIG. 2 is, for every cache node, publish a server name (in practice, more likely an IP (internet protocol) than a DNS (domain name system) or other human-readable name) and a “virtual node count,” e.g.,
server1, 4
server2, 2
server3, 2
   where server1 is the server name for cache node 104, which has 4 assigned virtual nodes (112-118); server2 in the server name for cache node 106, which has 2 assigned virtual nodes (120 and 122); server3 is the server name for virtual node 108, which has 2 assigned virtual nodes (124 and 126).

Consider a virtual ID space (denoted by reference numeral 208 in FIG. 2) ranging from 0 to VIRTUAL_ID_MAX. Each server name is hashed (for example, using a SHA1 hashing algorithm, which has a 160 bit output) to as many values in this range as its virtual instance count. The outputs of these hashes then form keys in a sorted list. For example, if the hash function had the following output:
server1, 1→11
server1, 2→12
server1, 3→21
server1, 4→22
server2, 1→15
server2, 2→0
server3, 1→26
server3, 2→14
   The sorted list is then
0→server2, 2
11→server1, 1
12→server1, 2
14→server3, 2
15 server2, 1
21 server1, 3
22 server1, 4
26 server3, 1

To determine where a cache key should be looked up, a binary search is carried out on the sorted list using the hash of the cache key, and then the server which has the least key in the sorted list that is greater than the value of the hash of the cache key is taken. For example, given a cache key http://obj1, if it hashes to 17, a binary search is carried out on the sorted list, the interval [15,21] is found, and the tie is broken by taking the greater of the two values, which is 21 in this case. The sorted list key 21 came from server1 and thus the cache key is looked up on that server. It should be noted that the above description is only one particular method of implementing consistent hashing in a distributed cache and variations can be made to this method based on, for example, suitability other embodiments.

As described above, the number of virtual nodes assigned to a cache node can be changed for better load balancing. In some embodiments, identifiers are assigned, to each of the number of virtual nodes, in ascending order of assignment. The identifiers reflect a lowest to highest order of virtual node assignment. For example, virtual node 112, which is the earliest or first-assigned virtual node to cache node 104, is assigned an identifier server1:1. Second virtual node 114 is assigned an identifier server1:2, third virtual node 116 is assigned an identifier server1:3, and fourth virtual node 118 is assigned an identifier server1:4.

In some embodiments, modifying the number of virtual nodes assigned to the cache node can include eliminating at least one virtual node of the number of virtual nodes, with the eliminated at least one virtual node being the node that has the lowest identifier. The at least one virtual node is typically eliminated from the cache node when the utilization level of the cache node is above a predetermined threshold. Thus, in the embodiment of FIG. 2, when the utilization level of cache node 104 is above a predetermined threshold, virtual node 112 is the first to be eliminated since it has the lowest identifier (server1:1).

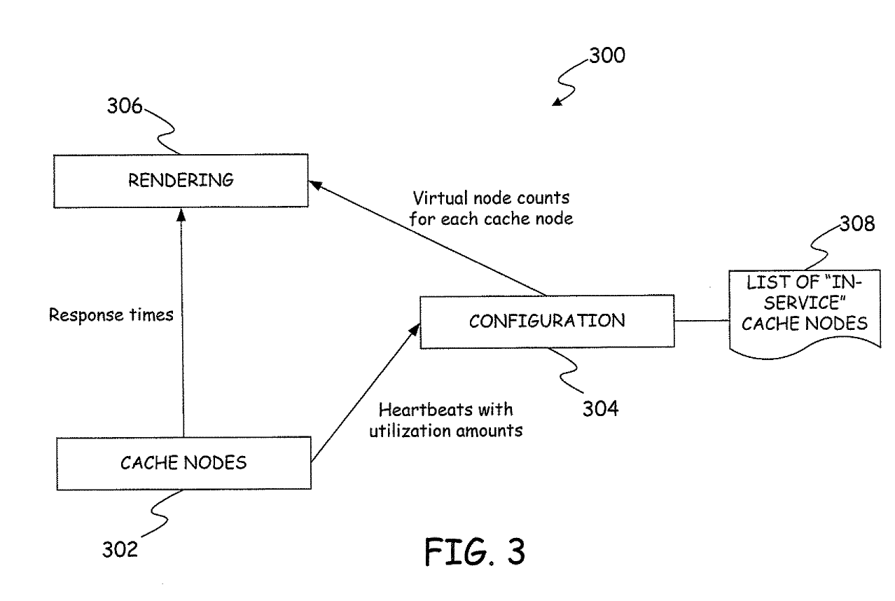

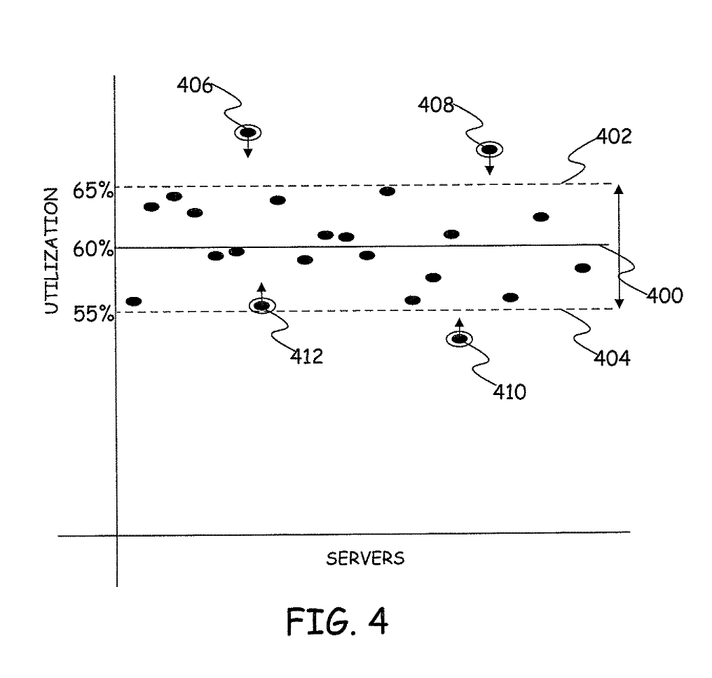

When the utilization level of the cache node is below a predetermined threshold, at least one new virtual node is added to the number of virtual nodes assigned to the cache node. In this case, the added at least one new virtual node is provided with an identifier that is higher than a highest existing identifier for the previously assigned virtual nodes. Thus, if a new virtual node is added to cache node 104, it will be assigned an identifier server1:5, for example. A detailed description of virtual node assignment and adjustment is provided below in connection with FIGS. 3 and 4.

FIG. 3 illustrates an exemplary system 300, which is essentially a dynamic load-aware distributed cache in accordance with one embodiment. System 300 includes, as its primary components, cache nodes 302, a configuration component (for example, a configuration server) 304 and a rendering component (for example, one or more rendering servers) 306.

System 300 is designed, in general, to include mechanisms for monitoring the health of cache nodes in order to change the load distributed to them. Additional cache nodes can also relatively easily be incorporated into system 300.

In an example embodiment of system 300, on starting up a cache node, it substantially immediately announces its presence to configuration component 304 and issues a heartbeat on a regular interval. The heartbeat contains a “utilization” metric (for example, an integer between 0 and 100) that approximates how much the cache node's resources are being used at that point, and hence the ability of the cache node to service requests in the future. It should be noted that this metric can change due to outside sources (other services running, backups, etc.), but diversion of load is still desired if those outside sources are decreasing the ability of the cache node to handle load, even though the cache nodes are the only entities being controlled through modifying the assignment of virtual nodes. In a specific embodiment, if configuration component 304 goes 3 heartbeat intervals without hearing a heartbeat from a cache node, it assumes that the cache node is down and reacts accordingly. In one embodiment, a heartbeat interval of 10 seconds is utilized.

In some embodiments, even if a cache node is identified as “alive,” it should also be specified as “in service” in configuration component 304 to receive load. This makes it relatively easy to add and remove servers from service.

In one embodiment, configuration server 304 includes a centralized table (denoted by reference numeral 308 in FIG. 3) of virtual node counts for each cache node. However, individual rendering servers within rendering component 306 can deviate from this official table as appropriate, for example, if they have recent evidence that suggests that one of the cache nodes is being overloaded.

Load balancing techniques, in accordance with the present embodiments, help shift loads across cache nodes based on the utilization metric reported to configuration component 304 in the cache node heartbeats. In accordance with one embodiment, load balancing is achieved by modifying virtual node count table 308 and adding or removing virtual nodes to different cache nodes. The load on a cache node is, in general, proportional to the number of virtual nodes a cache node has. As indicated earlier, cache nodes with relatively high utilization typically lose at least one virtual node, while cache nodes with low utilization are given at least one new virtual node.

Because virtual nodes are a relative measure, as mentioned above, configuration component 304 tries to keep roughly the same number of virtual instances total, no matter the system-wide load. This helps maintain that virtual node additions and deletions continue to provide a constant granularity of actual load reassignment. However, it should be noted that this ideal number of virtual nodes should be proportional to the number of cache nodes. This makes it less disruptive to the overall mapping of cache keys to cache nodes when servers are added or removed. For instance, if a cache node is added, it does not need to “steal” virtual nodes from other cache nodes; it only needs to add its own. In some embodiments, the ideal total number of virtual nodes is a multiple of the number of cache nodes in the system.

Rendering component 306 periodically polls configuration component 304 for virtual node counts. If configuration component 304 is down, rendering component 306 will continue operating on the last known virtual node counts until it comes back up and has re-established its virtual node count list.

In one embodiment, adjustment of virtual node counts occurs on every update interval. Because it is desirable to determine a result of a previous update before making another update, the update interval is a sum of the rendering component polling interval, the heartbeat interval and the time it takes to measure utilization. If an update is carried out in less than this amount of time, there can be a risk of adjusting twice based on the same data. It might take a non-negligible amount of time to measure utilization because it is desirable to compute an average over a short period in order to obtain a more stable reading.

On every update interval, a target number of virtual nodes is first established. If the system is already at the ideal number of virtual nodes, the target stays the same. If the total number of virtual nodes is above or below that number, the target is to get one closer to the ideal number of virtual nodes. This is carried out by configuration component 304, which calculates a mean utilization of all cache nodes and establishes a range of acceptable utilization by setting thresholds above and below the mean. The thresholds can be fixed numbers or percentages such as +/−5% above and below the mean. A virtual node is then removed from all cache nodes above the threshold and a virtual node is added to all cache nodes below it. If the target for the ideal number of virtual nodes is missed, then virtual nodes for cache nodes that are within the range are changed. Accordingly, if the total number of virtual nodes is above the ideal number of virtual nodes, sufficient servers with high utilization (starting from the maximum) are lowered in order to reach the target virtual node count. The same is true for the reverse. In a specific embodiment, no server will lose or gain more than one virtual instance during one update. This allows the system to guarantee that load is not migrated too rapidly. Because there is often some overhead to migrating load, it is desirable to bound this overhead such that even if the load measurements are provided by an adversary, the system continues to provide only slightly degraded service relative to optimum service. In a specific embodiment, this is provided by bounding the number of virtual nodes that any one server loses or gains during any one update.

In one embodiment, bringing in a new cache node (for example, a new server) is carried out by introducing it with the average number of virtual node counts per cache node. If this load is too much for the new server to accommodate, either for a transient period after the new server has been brought online or even when the new server has reached its steady state efficiency, a separate congestion control mechanism (which is outside the scope of this disclosure) addresses the problem until long term load balancing in accordance with the present embodiments can bring the load down.

In one embodiment, when a cache node is removed, the number of virtual nodes in the system is adjusted such that the average number of virtual node counts per cache node before and after the removal of the cache node is maintained substantially similar.

FIG. 4 is a graphical representation of load balancing, in a distributed cache, carried out in accordance with the present embodiments. In FIG. 4, each oval represents a cache node. Horizontal line 400 represents a mean utilization level, which, as noted above, is computed as a function of individual utilization levels of each cache node of the plurality of cache nodes. Horizontal lines 402 and 404 are pre-selected upper and lower utilization bounds, respectively, which are +/−5% in the embodiment of FIG. 4. The upper bound is referred to herein as a first utilization threshold and the lower bound is referred to as a second utilization threshold. In FIG. 4, cache nodes 406, 408 and 410 clearly lie outside the utilization bounds. However, if one virtual node is removed from each of cache nodes 406 and 408 to bring them within the utilization bounds, and one virtual node is added to cache node 410, another virtual node has to be added to a cache node to keep the total number of virtual nodes the same. Thus, as described earlier, another virtual node can be added to, for example, cache node 412.

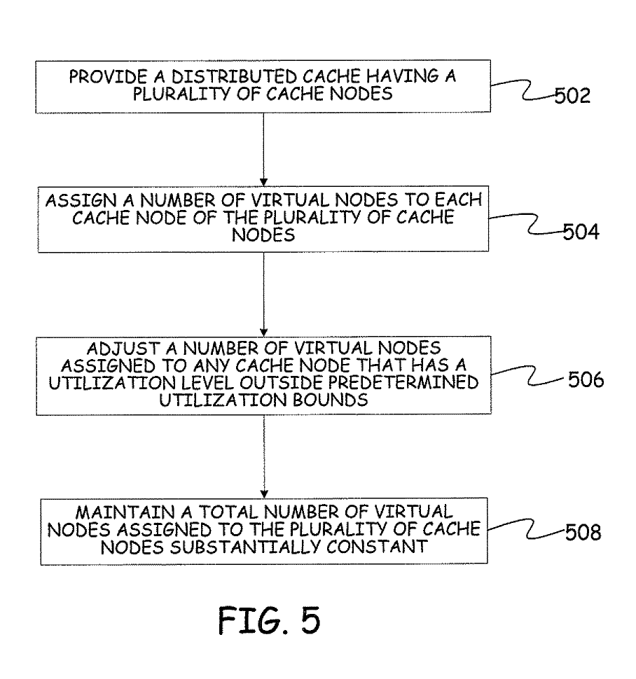

In conclusion, referring now to FIG. 5, a simplified flow diagram 500 of a caching method in accordance with one of the present embodiments is provided. A first step 502 in the method of FIG. 5 involves providing a distributed cache having a plurality of cache nodes. At step 504, a number of virtual nodes are assigned to each cache node of the plurality of cache nodes. Step 506 involves adjusting a number of virtual nodes assigned to any cache node that has a utilization level outside predetermined utilization bounds. At step 508, a total number of virtual nodes assigned to the plurality of cache nodes is maintained substantially constant.

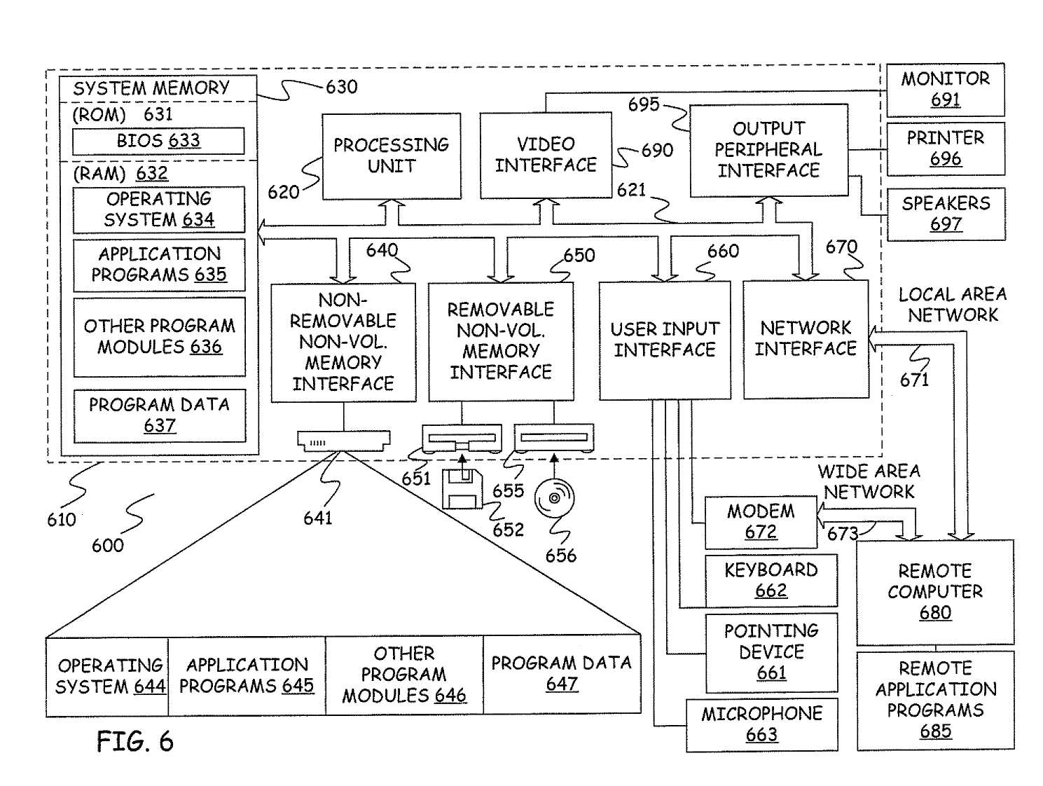

FIG. 6 illustrates an example of a suitable computing system environment 600 on which above-described caching embodiments may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600. Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, televisions, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 6, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. Still other input devices (not shown) can include non-human sensors for temperature, pressure, humidity, vibration, rotation, etc. These and other input devices are often connected to the processing unit 620 through a user input interface 660 that is coupled to the system bus, but may be connected by other interface and bus structures, such as a parallel port, game port or a USB. A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implementable on a computer readable medium, comprising:
providing a distributed system having a plurality of physical nodes;
mutably assigning a number of virtual nodes to each physical node of the plurality of physical nodes; and
maintaining a granularity of load migrated by migrating virtual nodes substantially unaltered in spite of any alterations made in the number of virtual nodes assigned to each physical node of the plurality of physical nodes or in a total number of physical nodes in the distributed system.

2. The method of claim 1 wherein mutably assigning a number of virtual nodes to each physical node of the plurality of physical nodes comprises assigning identifiers, to each of the number of virtual nodes, in ascending order of assignment, wherein the identifiers reflect a lowest to highest order of virtual node assignment.

3. The method of claim 2 and further comprising modifying the number of virtual nodes assigned to the physical node of the plurality of physical nodes.

4. The method of claim 1 wherein modifying the number of virtual nodes assigned to the physical node of the plurality of physical nodes is carried out in a manner that compensating modifications, including an addition followed by a deletion, result in the physical node having a different assignment of virtual nodes.

5. The method of claim 1 wherein the granularity of the load migrated by migrating virtual nodes is maintained substantially unaltered by maintaining a total number of virtual nodes in the distributed system substantially unaltered for a given number of physical nodes in the distributed system.

6. The method of claim 3 wherein modifying the number of virtual nodes assigned to the physical node of the plurality of physical nodes comprises adding at least one new virtual node to the number of virtual nodes assigned to the physical node, wherein the added at least one new virtual node is provided with an identifier that is higher than a highest existing identifier for the previously assigned virtual nodes.

7. The method of claim 6 wherein the at least one virtual node is added to the physical node when the utilization level of the physical node is below a predetermined threshold.

8. A method, implementable on a computer readable medium, comprising:
(a) providing a distributed system having a plurality of physical nodes;
(b) assigning a number of virtual nodes to each physical node of the plurality of physical nodes;
(c) measuring utilization on the physical nodes such that effects of outside sources, separate from any application being controlled, are also taken into account;
(d) adjusting a number of virtual nodes assigned to any physical node that has a utilization level outside predetermined utilization bounds.

9. The method of claim 8 and further comprising periodically repeating steps (c) and (d).

10. The method of claim 8 and further comprising determining a mean utilization level as a function of individual utilization levels of each physical node of the plurality of physical nodes.

11. The method of claim 10 wherein the predetermined utilization bounds comprise a first utilization threshold that is above the mean utilization level and a second utilization threshold that is below the mean utilization level.

12. The method of claim 8 wherein assigning a number of virtual nodes to each physical node of the plurality of physical nodes comprises assigning identifiers, to each of the number of virtual nodes, in ascending order of assignment, wherein the identifiers reflect a lowest to highest order of virtual node assignment.

13. The method of claim 12 wherein adjusting a number of virtual nodes assigned to any physical node that has a utilization level outside predetermined utilization bounds comprises eliminating at least one virtual node of the number of virtual nodes, wherein the eliminated at least one virtual node has a lowest identifier.

14. The method of claim 12 wherein adjusting a number of virtual nodes assigned to any cache node that has a utilization level outside predetermined utilization bounds comprises adding at least one new virtual node to the number of virtual nodes, wherein the added at least one new virtual node is provided with an identifier that is higher than a highest existing identifier for the previously assigned virtual nodes.

15. The method of claim 8 and further comprising utilizing a consistent hashing technique to access the physical node, of the plurality of physical nodes, with the help of the number of virtual nodes.

16. A system comprising:
a distributed system having a plurality of physical nodes, where each physical node is assigned a number of virtual nodes, and
wherein the number of virtual nodes assigned to any physical node that has a utilization level outside predetermined utilization bounds is modified such that even under adversarial load measurements, the system continues to provide only slightly degraded service relative to optimum service.

17. The system of claim 16 wherein the number of virtual nodes is utilized as part of a consistent hashing technique to map resources to physical nodes.

18. The system of claim 16 wherein each physical node of the plurality of physical nodes periodically reports its utilization level to a centralized component that aids in calculation of virtual node adjustments.

19. The system of claim 18 wherein the centralized component is further adapted to determine a mean utilization level as a function of individual utilization levels of each physical node of the plurality of physical nodes.

20. The system of claim 19 wherein the predetermined utilization bounds comprise a first utilization threshold that is above the mean utilization level and a second utilization threshold that is below the mean utilization level.
